(19) United States
(12) Patent Application Publication
(10) Pub. No.: US 2014/0071044 A1
(43) Pub. Date: Mar. 13, 2014

(54) DEVICE AND METHOD FOR USER INTERFACING, AND TERMINAL USING THE SAME

(71) Applicant: Electronics and Telecommunications Research Institute, Daejeon (KR)

(72) Inventor: Seung Woo NAM, Daejeon (KR)

(73) Assignee: Electronics and Telecommunications Research Institute, Daejeon (KR)

(21) Appl. No.: 14/023,025

(22) Filed: Sep. 10, 2013

(30) Foreign Application Priority Data
Sep. 10, 2012 (KR) 10-2010-0099780
Jul. 31, 2013 (KR) 10-2013-0090587

(51) Int. Cl. G06F 3/01

(52) U.S. Cl. CPC G06F 3/017
USPC 345/156

(57) ABSTRACT

There are provided a device and method for user interfacing, and a terminal using the same. The user interfacing method includes setting a reference image of an object to be used for user interfacing, recognizing the object to be used for user interfacing from input user-related images, determining depth-related movement of the object by comparing the recognized object and the reference image, and operating an application according to the depth-related movement of the object. Therefore, it is possible to control the terminal using user movement with respect to a distance between the terminal used by the user and the user.

### CLAIM FOR PRIORITY

This application claims priority to Korean Patent Applications No. 2012-0099780 filed on Sep. 10, 2012 and No. 2013-0090587 filed on Jul. 31, 2013 in the Korean Intellectual Property Office (KIPO), the entire contents of which are hereby incorporated by reference.

### BACKGROUND

1. Technical Field

Example embodiments of the present invention relate to user interfacing, and more specifically, to a device and method for providing user interfacing to a mobile terminal using a user's gesture, and a terminal using the same.

2. Related Art

A user interface refers to a device or software that helps smooth interaction between a user and a device. The user interface is mainly used in, for example, computers, electronic devices, industrial equipment, and home appliances, and helps the user to interact with a corresponding device.

Examples of typical user interfaces include a command line interface in which the user inputs a command using a keyboard to operate a program, a menu driven interface in which the user selects a menu to operate a program, and a graphic user interface in which the user operates a graphic display program using a pointing device such as a light pen, mouse, control ball, and joystick.

Due to development of technology, natural and intuitive user interfaces between the user and the device breaking away from conventional typical types are increasing. A representative example of such an interface is a 3D user interface.

Kinect™ of Microsoft, one of 3D interfaces, provides games and entertainment services by recognizing a user's gesture without using a controller. As a full body gesture for interaction between content and the user, before the content starts, Kinect is configured to make an initial gesture of the user, for example, lifting both hands.

However, user interfaces used for a mobile terminal in addition to Kinect have limitations of interaction with 3D content (application) according to the user's gesture. In particular, there are many limitations due to a recognition range of the user and a display size of the mobile terminal so that it is difficult to use.

Accordingly, it is necessary to provide a user interface that is more suitable and natural for the mobile terminal.

### SUMMARY

Accordingly, example embodiments of the present invention are provided to substantially obviate one or more problems due to limitations and disadvantages of the related art.

Example embodiments of the present invention provide an interfacing method between a terminal used by a user and the user.

Example embodiments of the present invention also provide a user interface device using the above interfacing method.

Example embodiments of the present invention also provide a terminal including the above user interface.

In some example embodiments, a user interfacing method includes setting a reference image of an object to be used for user interfacing, recognizing the object to be used for user interfacing from input user-related images, determining depth-related movement of the object by comparing the recognized object and the reference image, and operating an application according to the depth-related movement of the object.

The object to be used for user interfacing may be a part of a user's body.

The part of the user's body may include at least one of the user's hand, finger, palm, face, lips, nose, eyes, and head.

The determining of the depth-related movement of the object by comparing the recognized object and the reference image may include determining a depth-related position of the object image by comparing a size of the object image recognized in the input user-related images and a size of the reference image.

The size of the object image recognized in the input user-related images may be defined by a width, length, or area of the image.

The setting of the reference image of the object to be used for user interfacing may include setting a part of the user's body to be used as an object of the reference image, synthesizing images related with the set part of the user's body input from a camera and virtual graphics related with the reference image, and displaying the result, matching the images related with the set part of the user's body input from the camera and the virtual graphics, and storing the images related with a part of the user's body matched in the virtual graphics as the reference image.

The recognizing the object to be used for user interfacing from input user-related images may include extracting features related with the object in entire images input from a camera.

The depth-related movement may be movement with respect to a distance between a camera and a part of a user's body set as the object.

According to another aspect of the invention, the user interfacing method may also reflect a plane direction (or a horizontal direction) movement with respect to the camera in addition to the depth-related movement of the user to user interfacing.

In other example embodiments, a user interface device includes a receiving unit configured to receive user-related images, a feature extracting unit configured to extract object-related images to be used for user interfacing from input user-related images, a gesture recognition unit configured to determine depth-related movement of the object by comparing the extracted object-related images and a reference image, and a content operating unit configured to operate content according to the depth-related movement of the object.

In this case, movement of the object may include the depth-related movement and movement in a plane direction.

The user interface device may further include a display unit configured to synthesize the extracted object-related image provided by the gesture recognition unit and the reference image and display the result.

The object to be used for user interfacing may be a part of a user's body.

The part of the user's body may be at least one of the user's hand, finger, palm, face, lips, nose, eyes, and head.

The gesture recognition unit may determine a depth-related position of the object image by comparing a size of the object image recognized in the input user-related image and a size of the reference image.

The size of the object image recognized in the input user-related images may be defined by a width, length, or area of the image.

The depth-related movement may be movement with respect to a distance between a camera and a part of a user's body set as the object.

The reference image may be the object image input to the camera when the object to be used for user interfacing is positioned at a reference point.

In still other example embodiments, a terminal includes a user interface unit configured to extract object-related images to be used for user interfacing from input user-related images, determine depth-related movement of the object by comparing the extracted object-related images and a reference image, and operate content according to the depth-related movement of the object, and a data storage unit configured to store an object-related reference image to be used for user interfacing.

The user interface unit may be configured to synthesize graphics related with a part of the user's body used as an object of the reference image and an actual image of the object input from a camera and display the result, and set the object image matching the graphics as the reference image when the object image input from the camera matches the graphics.

According to the invention described above, it is possible to control the terminal using user movement with respect to a distance between the terminal used by the user and the user, and the user can use an electronic device more freely.

### BRIEF DESCRIPTION OF DRAWINGS

Example embodiments of the present invention will become more apparent by describing in detail example embodiments of the present invention with reference to the accompanying drawings, in which:

FIG. 1 is a block diagram illustrating a configuration of a user interface device according to the invention.

FIG. 2 is a conceptual diagram illustrating operations of a user interfacing method according to the invention.

FIG. 3 is a flowchart illustrating operations of a reference image setting method for gesture recognition according to the invention.

FIG. 4 is a flowchart illustrating operations of the user interfacing method according to the invention.

FIG. 5 is a block diagram illustrating a configuration of a terminal according to the invention.

### DESCRIPTION OF EXAMPLE EMBODIMENTS

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The terminology used herein is defined by considering a function in the embodiments, and meanings may vary depending on, for example, a user or operator's intentions or customs. Therefore, the meanings of terms used in the embodiments should be interpreted based on the scope throughout this specification.

The term “terminal” used in the present specification may be referred to as a mobile station (MS), user equipment (UE), a user terminal (UT), a wireless terminal, an access terminal (AT), a terminal, a subscriber unit, a subscriber station (SS), a wireless device, a wireless communication device, a wireless transmit/receive unit (WTRU), a mobile node, a mobile, or other terms.

Various embodiments of the terminal may include a cellular phone, a smartphone having a wireless communication function, a personal digital assistant (PDA) having a wireless communication function, a wireless modem, a portable computer having a wireless communication function, a photographing apparatus such as a digital camera having a wireless communication function, a gaming apparatus having a wireless communication function, a music storing and playing electronic product having a wireless communication function, an Internet electronic product enabling an wireless Internet access and browsing, and a portable unit or terminals integrating combinations of corresponding functions, but is not intended to be limiting.

Hereinafter, exemplary embodiments of the invention will be described in detail with reference to the accompanying drawings. In order to facilitate overall understanding of the invention, like reference numerals in the drawings denote like elements, and thus the description thereof will not be repeated.

The invention relates to technology for providing a user interface using depth information between a terminal and a user, and more specifically, provides a method of obtaining depth information through calibration using features of a part of the user's body before content or an application starts.

In order to three-dimensionally interact with the content (application) operated in a mobile terminal, initialization is necessary before the content starts. For example, it is assumed that the user's finger captured by a camera equipped in the mobile terminal is used to interact with the content. In this case, when a depth value is identified according to a size of the finger and is used for user interfacing, since each user has different finger sizes and a size of the finger changes according to a distance between the camera equipped in the mobile terminal and the user's finger, it is also necessary to initialize information on a finger size before the content starts (for example, content is operated by recognizing the user's initial gesture of lifting both hands in Kinect).

By extending interaction, another part of a body in addition to the user's finger is used to interface in a Z direction (a distance direction between a camera and a user). For example, a face or pupil of the user may be used. Also in this case, it is necessary to initialize, for example, a size of the face, a distance between eyes, and an initial position of the pupil.

Therefore, the invention also provides an initialization method for user interfacing.

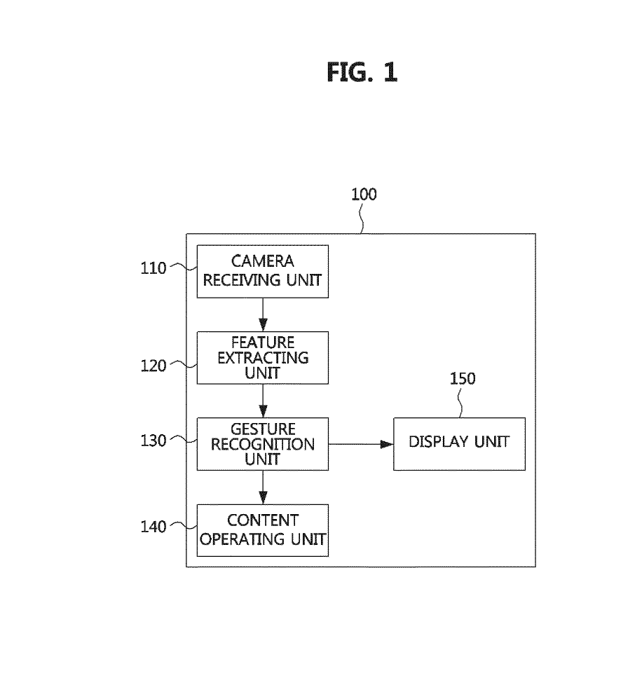

FIG. 1 is a block diagram illustrating a configuration of a user interface device according to the invention.

The user interface device according to the invention may be embedded or equipped in various terminals used by the user.

Components to be described below are defined by a functional classification rather than a physical classification and may be defined by functions performed by each component. Each of the components may be implemented by hardware and/or a program code performing each function, and a processing unit, and functions of two or more components may be included in one component. Therefore, a name given to the component in the embodiment is meant to imply a representative function performed by each component rather than to physically distinguish each component. It should be noted that the technological scope of the invention is not limited to the name of the component.

In FIG. 1, the user interface device 100 according to the embodiment of the invention may include a camera receiving unit 110, a feature extracting unit 120, a gesture recognition unit 130, a content operating unit 140, and a display unit 150.

Images input to the camera receiving unit 110 may include all images input from an image sensor and a time of flight (TOF) sensor. The images received in the camera receiving unit 110 may also include an RGB image, a depth map, and an infrared image.

Here, the image sensor is an image detection element, for example, a charge coupled device (CCD). In the CCD, 100,000 or more detection elements are provided in a chip having a coin size and images focusing on a chip surface are accumulated in each element as a charge packet. This packet is output at a high speed by a charge transmission mechanism, is transformed, and then is displayed as an image. The elements in the CCD serve as a detection array, and an area thereof is divided and used for, for example, accumulation and output.

The TOF sensor is generally used to measure a depth in a 3D camera. A distance from a subject is calculated by measuring an elapsed time from light (infrared wavelength) transmission to reception of signals reflected by the subject. A depth camera based on the TOF is difficult to generate a pulse of light, and measures a depth by recognizing a phase difference of reflected waves due to high speed in the sensor.

The feature extracting unit 120 extracts images related with a particular part of the user's body, for example, eyes, head, face, hand, and finger, to be used for gesture recognition according to the invention from the images input from the camera receiving unit 110.

According to the embodiment of the invention, the feature extracting unit 120 detects the user's both eyes from the input images and extracts a distance between the both eyes (including pupils) as a feature of a corresponding image. Moreover, the feature extracting unit 120 detects a finger area from the input images, extracts information on a length and thickness of the finger, and delivers the result to the gesture recognition unit 130. Therefore, the gesture recognition unit 130 uses a corresponding feature.

Before the user operates the content or application, the gesture recognition unit 130 provides graphics information on virtual reference images related with the images input from the camera to the display unit 150. The gesture recognition unit 130 also provides an actual image having color or black and white input from the camera, or feature area images extracted from the actual image to the display unit 150. In this case, the image having color or black and white input from the camera may be, for example, a depth map or an infrared image.

In an operation of setting a reference image for calibration, the gesture recognition unit 130 automatically adjusts zoom of the camera such that virtual graphics outline matches eyes' outlines used as an object of the input image at the user's actual eyes positions. On the other hand, when the user adjusts the distance to match virtual positions of the both eyes, it is possible to recognize the user's feature to be used as the reference image when the user or a part of the user's body is positioned at a reference point. In this case, as the reference point, an adjusted zoom or a position of the user or a part of the user's body is used. When the zoom is not used, the user directly matches a part of the body to the virtual graphics outline, sets the reference point of an object to be recognized, and stores an object image.

As the user moves away from the camera, the distance between the user's both eyes decreases accordingly. As the user moves closer to the camera, the distance between the user's both eyes increases accordingly. These changes may be used for interfacing between the content and the user.

In another embodiment of the invention, a method of using both edge points of the user's lips may be used. When the both edge points of the lips are used, a distance between the camera and the user is calculated by a distance between a first point and a second point. As the distance between two the points increases, the distance between the camera and the user decreases. This change may be used for user interfacing.

In still another embodiment of the invention, the finger may be used as the feature. In this case, images received in the camera and a thickness or length of the finger serving as a reference are graphically synthesized and displayed.

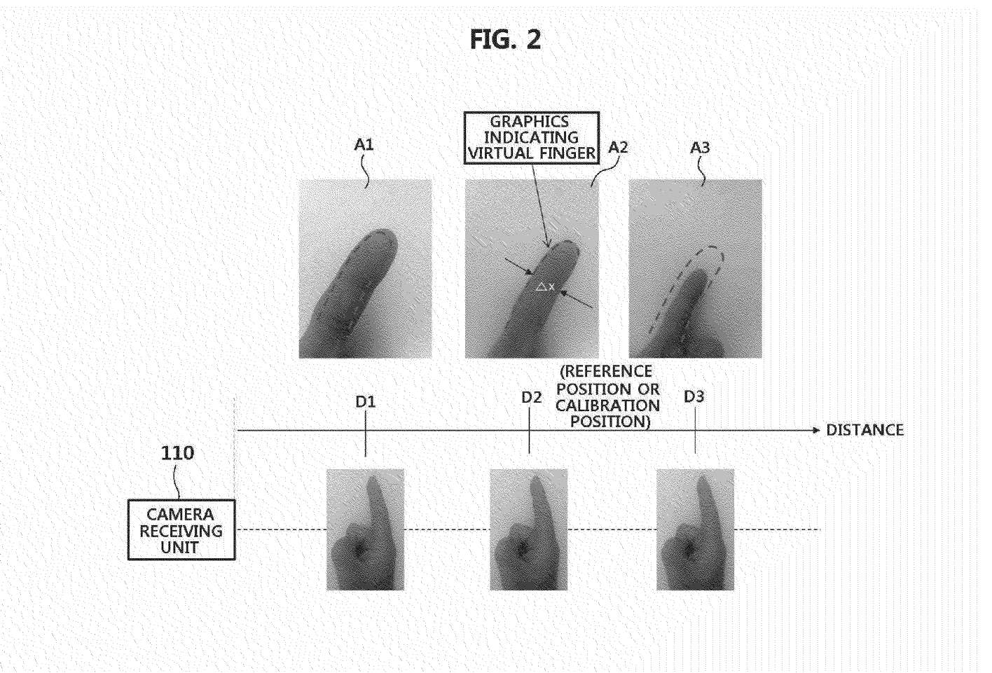

FIG. 2 will describe in detail the following operations. The user matches his or her own finger, that is, a length or thickness of an actual finger image, and a virtual graphic position. When the user's actual finger image matches the virtual graphic position, the user's finger position is used as a reference position, and a distance between the camera and the user's finger is used as a reference distance. In this case, depending on characteristics of the camera, data for calibration may be previously stored.

As the user's finger position moves closer to the camera with respect to the reference distance, a thickness of the user's finger image input to the camera increases and a length thereof increases. On the other hand, as the user's finger position moves farther than the reference distance from the camera, the thickness of the finger decreases and the length thereof decreases.

When these changes are used, it is possible to calculate the distance between the camera and the user from the user's body image such as the finger or eyes, input to the camera.

The display unit 150 synthesizes the actual image input from the camera provided in the gesture recognition unit 130 and virtual graphics related with the reference image, and displays the result.

Here, examples of 3D image displaying methods in the display unit may include a stereoscopic method in which different images are respectively input to left and right eyes so that the user gets a sense of three-dimensions, and a motion parallax method in which a distance of an object and an amount of movement in left and right change according to the user's visual point.

Meanwhile, the depth map is one of important factors to represent 3D images and represents a distance between an object positioned in a 3D space and a camera capturing the object in units of black and white or color. For example, when the depth map is represented as black and white, as the object moves closer to the camera, the color becomes white, and as the object moves farther from the camera, the color becomes black. In general, when left and right eyes of a human observe one stereoscopic object, since the object is observed at slightly different positions, slightly different pieces of image information are observed through left and right eyes of an observer. The observer combines these slightly different pieces of image information, obtains depth information on a stereoscopic object, and then gets a sense of three-dimensions therefrom.

In addition, when the display unit 150 displays such that the actual image and the reference image are graphically synthesized, an augmented reality (AR) method may be used to display.

The AR method is technology for displaying a 3D virtual object to appear overlapped in a real world of the user, and refers to technology for combining and supplementing a virtual object and information created by computer technology into the real world. Since a virtual world having additional information is combined into the real world in real time to display as one image, it is also called mixed reality. In virtual reality technology, since the user is allowed to be immersed in a virtual environment created by computer graphics, it is difficult to see a real environment. However, in AR technology, since the virtual object is mixed into the real environment, it is possible for the user to be provided with more realistic additional information than the real environment.

The content operating unit 140 identifies the user's intention according to a distance value of the user among information output from the gesture recognition unit 130 and controls corresponding content according to the identified user's intention.

That is, when the user matches a reference position of a hand or face, or camera zoom is automatically matched, and calibration is thereby completed and the reference image is set, as a part of the user's body corresponding to the reference image moves farther from the reference position, a thickness or length of the hand decreases accordingly. Therefore, it is detected that the hand moves farther from the camera, and corresponding content may be controlled.

For example, when the user's hand moves farther from the camera, a size of an icon of the corresponding content may be reduced. On the other hand, when the user's hand moves closer to the camera from the reference position, a thickness or length of the hand increases. Therefore, this change is used to control the content. For example, when the user's hand moves closer to the camera, the size of the icon of the corresponding content may be enlarged.

FIG. 2 is a conceptual diagram illustrating operations of a user interfacing method according to the invention.

According to the invention illustrated in FIG. 2, in stereoscopic 3D content or holographic content, the distance between the camera and the user, for example, the distance between the camera and the user's finger, is measured in real time to control stereoscopic content or application having a depth.

In other words, it is possible to interface with x and y directions of the user in a plane direction which is perpendicular from the camera and a z direction which is a distance direction from the camera.

In FIG. 2, the camera receiving unit 110 is positioned in a left side and it represents a condition in which the user's finger moves farther from the camera receiving unit 110 toward a right side.

In FIG. 2, the user's finger is positioned at three points of d1, d2, and d3. As the point moves from d1 to d3, it is understood that the distance from the camera receiving unit 110 increases.

The user's finger images at each point are shown in the above of the three points of d1, d2, and d3. As illustrated, al represents an image when the user's finger is positioned at d1, a2 represents an image when the user's finger is positioned at d2, and a3 represents an image when the user's finger is positioned at d3.

Red dotted lines indicated in the images of a1, a2, and a3 are graphics for displaying a virtual finger, and are virtual graphics related with the reference image that is used as a reference to calculate a distance (z) between the camera receiving unit 110 and the user's finger.

In FIG. 2, a position d2 is set as a reference position or calibration position.

After the user places the finger at the position d2 in accordance with the graphics and sets the position as the reference position, an actual finger image is larger than the reference image in the image a1 when the user is positioned at the position d1 closer than d2 with respect to the reference position d2, and an actual finger image is smaller than the reference image in the image a3 when the user is positioned at the position d3 farther than d2.

When a mathematical approach is applied to a concept in FIG. 2, the distance between the camera and the user's hand becomes a function of a thickness and length of the finger.

That is, according to the embodiment of the invention, the distance between the camera and the user may be represented as a function of a thickness of the finger as defined by the following Equation 1. In this case, the distance between the camera and the user is inversely proportional to the thickness of the finger.

z=f(Δx) Equation 1

Here, z indicates a distance between a camera and a user's finger, and Δx indicates a thickness of the finger.

According to another embodiment of the invention, the distance between the camera and the user's finger may be represented as a function of a length of the finger as defined by the following Equation 2. In this case, the distance between the camera and the user is inversely proportional to the length of the finger.

z=f(Δy) Equation 2

Here, z indicates a distance between a camera and a user's finger, and Δy indicates a length of the finger.

In the above examples, a size of the image according to the invention may be defined by a width or length of the image, and a size of the image recognized for user interfacing according to the invention may be defined by, for example, a width, length, or area of the image.

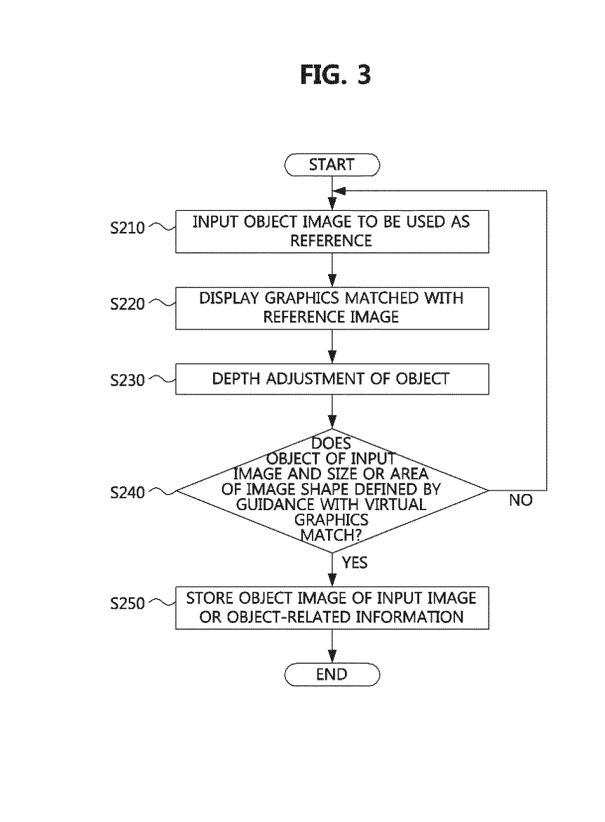

FIG. 3 is a flowchart illustrating operations of a reference image setting method for gesture recognition according to the invention.

In FIG. 3, the method of setting a reference image, that is used as a reference for gesture recognition of the user, used for user interfacing according to the invention will be described.

The image used as the reference for gesture recognition according to the invention may include images of various parts of the user's body, for example, a finger, both eyes, mouth, and head, that can be used to detect a distance according to the user movement.

The image used as a reference in gesture recognition according to the invention may include images of, for example, a finger, hand, palm, face, lips, nose, both eyes, one eye (for example, a length of one eye may be used as a feature), and head, as a part of the user's body.

In order to set the reference image according to the invention, images related with an object to be used as the reference are input first (S210). Here, the object may be a user or a part of the user's body.

Then, the object to be used as the reference is extracted from the input images. In this case, the object to be used as the reference may be previously determined by a corresponding application or by the user. In this case, the object may be extracted by a method in which a feature is extracted among entire input images and an object image is extracted focusing on the object.

The user interfacing method according to the invention displays the input image and displays images such that virtual graphics matching with the reference image overlaps the input image (S220). In this case, as illustrated in FIG. 2, the graphics may be indicated with dotted lines or displayed with the input image overlapped thereon as a transparent image, in order for the user or the terminal to easily recognize.

Then, depth adjustment of the object is performed (S230). Here, the depth adjustment may be performed such that the user sees the displayed virtual graphics and moves the object to be used for user interfacing forward or backward, that is, in a vertical direction, with respect to the camera. The depth adjustment may also be automatically performed by the terminal using the camera zoom equipped in the terminal that provides user interfacing according to the invention.

The terminal determines whether the object of the input image matches with a size or area of an image shape defined by guidance with the virtual graphics (S240).

In this case, the virtual graphics may be represented as dotted lines surrounding outlines of the image or may be displayed with the object of the input image overlapped thereon as a transparent image, or may be represented as various types.

Here, the user or the terminal may determine whether the input object image matches a size or area of an image shape defined by the virtual graphics. For example, the user may press an OK button when it is determined that the two images sufficiently match or the terminal may automatically issue an OK sign when certain conditions are satisfied.

When it is determined that the input object image matches the image shape defined by the virtual graphics, the object image in the input image or object-related information, for example, a size, area, length, and width of the object is stored (S250). Therefore, the setting of the reference image to be used for user interfacing according to the invention is completed.

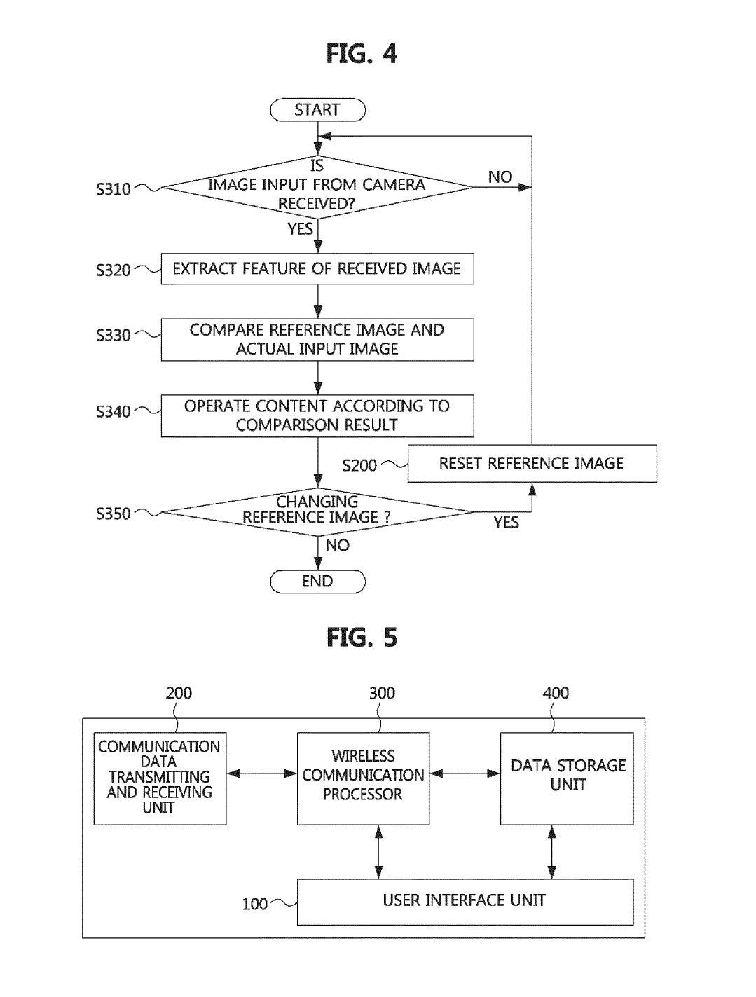

FIG. 4 is a flowchart illustrating operations of the user interfacing method according to the invention.

In the following embodiment description, while each operation configuring the method of the invention may be understood as the operation performed in a corresponding component in the user interface device described in FIG. 1, each operation configuring the method according to the invention is limited to a its own function defining each operation. That is, it should be noted that the subject of each operation is not limited to a name of the component exemplified to perform each operation.

In order to perform user interfacing according to the invention, as described in operations of FIG. 3, reference image setting processes for interfacing are necessary.

When the setting of the reference image is completed, images input to the camera are received for user interfacing (S310).

A feature of the image for user interfacing is extracted from the input image (S320). Here, the feature of the image according to the invention is a part of the user's body to be used as an object of the reference image. Various part of the user's body that can be used for user interfacing, for example, a finger, both eyes, and head, may be used.

The extracted image feature is compared with the reference image that is determined in the reference image setting process and stored in the terminal (S330).

The terminal or the user interface device according to the invention operates content using calibration data obtained by comparing the actually extracted image feature and the reference image (S340). For example, when the user's finger is used as the reference image, it is possible to determine whether a thickness of the finger as the actually extracted feature is smaller/larger than that of the reference image, and therefore the result can be used for content operation.

Here, when two or more reference images are set for user interfacing, the number of partial images extracted in the feature extracting operation (S320) is two or more according to the number of reference images, and in operation (S330) of comparing a plurality of extracted features with the reference image, two or more results in which actually input partial images used as two or more features are compared with two or more reference images are comprehensively determined and used for operating content or applications.

In this case, a process of setting two or more reference images is necessary, and movements of two or more reference images are comprehensively determined and used for user interfacing.

Meanwhile, as described above, when the user wishes to change the reference image to be used for interfacing (S350), the reference image for user interfacing is reset (S200).

Then, when the image is input from the camera, the user interface according to the invention extracts a feature of the image input from the camera according to the reset reference image, calibrates a corresponding feature, and operates corresponding content according to the calibrated data.

While movement used for user interfacing is described focusing on depth-related movement of the object in FIG. 4, the user interfacing method according to another aspect of the invention also applies a plane direction (or a horizontal direction) movement with respect to the camera in addition to the depth-related movement of the user to user interfacing.

FIG. 5 is a block diagram illustrating a configuration of the terminal according to the invention.

The terminal exemplified in the invention may include a mobile communication terminal, for example, a smart phone.

As illustrated in FIG. 5, the mobile communication terminal according to the invention may include a user interface unit 100, a communication data transmitting and receiving unit 200, a wireless communication processor 300, and a data storage unit 400.

The user interface unit 100 according to the invention extracts an object-related image to be used for user interfacing from input user-related images, determines movement of the object by comparing the extracted object-related images and the reference image, and operates content or applications according to the movement of the object.

In this case, the movement of the object includes depth-related movement and movement in a plane direction.

The user interface unit 100 synthesizes actual images of the object input from the camera and virtual graphics related with a part of the user's body used as an object of the reference image, and displays the result, and sets the object image as the reference image when the object image input from the camera matches the graphics.

The communication data transmitting and receiving unit 200 transmits and receives data, that is, wireless communication data, according to a unique role of the wireless communication terminal In this case, the wireless communication data include a voice call of the user and data other than the voice. The communication data transmitting and receiving unit 200 transmits communication data to a base station according to specifications supported by a corresponding terminal and receives communication data transmitted from the base station to the terminal The terminal according to the invention and mobile communication systems communicating with such a terminal may follow various communication specifications, for example, 3GPP and IEEE.

The wireless communication processor 300 performs reception processing of data received by the communication data transmitting and receiving unit 200, provides the data in a form of voice, text, and image to the user, and stores the received data in the data storage unit 400 according to the user's selection.

The wireless communication processor 300 also performs transmission processing of voice call data input from the user and delivers the result to the communication data transmitting and receiving unit 200.

The data storage unit 400 stores object-related reference images and information related with reference images to be used for user interfacing according to the invention.

The data storage unit 400 also stores various data generated in wireless communication of the terminal. The data to be stored in the data storage unit 400 may include various text, image, and contact information such as phone numbers, which are sent and received between user terminals. The data storage unit 400 also stores various content and application programs that can be executed in the user terminal.

Various data to be stored in the data storage unit 400 may be stored in a form of a database. The term “database” used in this specification refers to a functional component for storing information rather than a strict form of database such as a relational and object-oriented database, and the database may be implemented in a variety of forms.

For example, the database may also be configured as a simple information storing component in a form of file-base used in the invention.

According to the embodiments of the invention, it is possible to control the terminal using user movement with respect to the distance between the terminal used by the user and the user, that is, using the depth information of the user movement.

Therefore, it is possible for the user to more freely use an electronic device using the interfacing according to the invention.

While the example embodiments of the present invention and their advantages have been described in detail, it should be understood that various changes, substitutions and alterations may be made herein without departing from the scope of the invention as defined by the following claims.

What is claimed is:

1. A user interfacing method comprising;
setting a reference image of an object to be used for user interfacing;
recognizing the object to be used for user interfacing from input user-related images;
determining depth-related movement of the object by comparing the recognized object and the reference image; and
operating an application according to the depth-related movement of the object.

2. The method of claim 1, wherein the object to be used for user interfacing is a part of a user's body.

3. The method of claim 2, wherein the part of the user's body includes at least one of the user's hand, finger, palm, face, lips, nose, eyes, and head.

4. The method of claim 1, wherein the determining of the depth-related movement of the object by comparing the recognized object and the reference image includes determining a depth-related position of the object image by comparing a size of the object image recognized in the input user-related images and a size of the reference image.

5. The method of claim 4, wherein the size of the object image recognized in the input user-related images is defined by a width, length, or area of the image.

6. The method of claim 1, wherein the setting of the reference image of the object to be used for user interfacing includes:
setting a part of the user's body to be used as an object of the reference image;
synthesizing images related with the set part of the user's body input from a camera and virtual graphics related with the reference image, and displaying the result;
matching the images related with the set part of the user's body input from the camera and the virtual graphics; and
storing the images related with a part of the user's body matched in the virtual graphics as the reference image.

7. The method of claim 1, wherein the recognizing the object to be used for user interfacing from input user-related images includes extracting features related with the object in entire images input from a camera.

8. The method of claim 1, wherein the depth-related movement is movement with respect to a distance between a camera and a part of a user's body set as the object.

9. A user interface device comprising:
a receiving unit configured to receive user-related images;
a feature extracting unit configured to extract object-related images to be used for user interfacing from input user-related images;
a gesture recognition unit configured to determine depth-related movement of the object by comparing the extracted object-related images and a reference image; and
a content operating unit configured to operate content according to the depth-related movement of the object.

10. The device of claim 9, further comprising a display unit configured to synthesize the extracted object-related image provided by the gesture recognition unit and the reference image, and display the result.

11. The device of claim 9, wherein the object to be used for user interfacing is a part of a user's body.

12. The device of claim 11, wherein the part of the user's body is at least one of the user's hand, finger, palm, face, lips, nose, eyes, and head.

13. The device of claim 11, wherein the gesture recognition unit determines a depth-related position of the object image by comparing a size of the object image recognized in the input user-related images and a size of the reference image.

14. The device of claim 13, wherein the size of the object image recognized in the input user-related images is defined by a width, length, or area of the image.

15. The device of claim 9, wherein the depth-related movement is movement with respect to a distance between a camera and a part of a user's body set as the object.

16. The device of claim 9, wherein the reference image is the object image input to the camera when the object to be used for user interfacing is positioned at a reference point.

17. A terminal comprising:
a user interface unit configured to extract object-related images to be used for user interfacing from input user-related images, determine depth-related movement of the object by comparing the extracted object-related images and a reference image, and operate content according to the depth-related movement of the object; and
a data storage unit configured to store an object-related reference image to be used for user interfacing.

18. The terminal of claim 17, wherein the user interface unit is configured to synthesize graphics related with a part of the user's body used as an object of the reference image and an actual image of the object input from a camera and display the result, and set the object image matching the graphics as the reference image when the object image input from the camera matches the graphics.

19. The terminal of claim 17, wherein the depth-related movement is movement with respect to a distance between a camera and a part of a user's body set as the object.
